(19) United States
(12) Patent Application Publication
(10) Pub. No.: US 2026/0160935 A1
(43) Pub. Date: Jun. 11, 2026

(54) Backlight module and display device

(71) Applicant: Coretronic Corporation, Hsin-Chu (TW)

(72) Inventors: LIANG-KUO TSAO, Hsin-Chu (TW); CHUN-HSIANG HSU, Hsin-Chu (TW); YEN-HAO LIN, Hsin-Chu (TW); WEI-HSUAN CHENG, Hsin-Chu (TW)

(21) Appl. No.: 19/399,670

(22) Filed: Nov. 25, 2025

(30) Foreign Application Priority Data
Dec. 6, 2024 (CN) 202423016393.3

(51) Int. Cl. F21V 8/00

(52) U.S. Cl. CPC G02B 6/0053

(57) ABSTRACT

A backlight module includes the following features. A light guide plate is opposite a light-emitting element. An inverse prism sheet is disposed on a light-emitting surface of the light guide plate and has prism columns facing the light-emitting surface. The prism columns extend in a direction. A first prism sheet and a second prism sheet are sequentially disposed on a side of the inverse prism sheet facing away from the light guide plate, and each have first prism columns and second prism columns. An included angle between the direction and the first prism column is between 85 and 95 degrees, and an included angle between the first prism column and the second prism column is between 85 and 95 degrees. Two bottom angles of each of the second the prism columns are between 51 and 61 degrees. A display device having a backlight module is also provided.

### CROSS-REFERENCE TO RELATED APPLICATION

This application claims the priority benefit of China application (No. 202423016393.3), filed on Dec. 6, 2024. The entirety of the above-mentioned patent application is hereby incorporated by reference herein and made a part of this specification.

### TECHNICAL FIELD

The invention relates to a light source module, and more particularly to a backlight module and a display device adopting the backlight module.

### BACKGROUND

Components of a liquid crystal display mainly include a backlight module, a display panel, and a frame, etc. The backlight module can be divided into an edge-type backlight module and a direct-type backlight module according to different light emission directions of a light source. The direct-type backlight module has an advantage of better uniformity as a surface light source, while the edge-type backlight module has advantages of low energy consumption and low cost. Therefore, the edge-type backlight module and the direct-type backlight module have different market orientations.

Generally, brightness of the light emitted from the LCD display is mostly highest at a normal viewing angle whether the backlight module is an edge-lit backlight module or a direct-lit backlight module, and the brightness is decreased as the viewing angle is deviated from the normal viewing angle, resulting in a limited viewing angle of the LCD display. Therefore, if the viewing angle of the LCD display needs to be improved, the conventional technology can only increase the brightness of the side viewing angle by increasing the power consumption of the backlight module, which results in energy waste and shortened product service life.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure were acknowledged by a person of ordinary skill in the art.

### SUMMARY

In order to achieve one or a portion of or all of the objects or other objects, an embodiment of the invention provides a backlight module including a light-emitting element, a light guide plate, an inverse prism sheet, a first prism sheet, and a second prism sheet. The light guide plate has a light incident surface and a light-emitting surface connected to the light incident surface, and the light incident surface is opposite to the light-emitting element. The inverse prism sheet is disposed on the light-emitting surface of the light guide plate. The inverse prism sheet has a plate body and a plurality of prism columns. The prism columns are disposed on a side of the plate body facing the light-emitting surface, and the prism columns extend toward a direction. The first prism sheet is disposed on a side of the inverse prism sheet facing away from the light guide plate, and the first prism sheet has a first plate body and a plurality of first prism columns. The first prism columns are disposed on a side of the first plate body facing away from the inverse prism sheet, and the first prism columns extend toward a first direction. An included angle between the direction and the first direction is between 85 degrees and 95 degrees. The second prism sheet is disposed on a side of the first prism sheet facing away from the inverse prism sheet, and the second prism sheet has a second plate body and a plurality of second prism columns. The second prism columns are disposed on a side of the second plate body facing away from the first prism sheet, and the second prism columns extend toward a second direction. An included angle between the first direction and the second direction is between 85 degrees and 95 degrees. Each of the second prism columns has two bottom angles, the two bottom angles are connected to a surface of the second plate body, and each of the two bottom angles is between 51 degrees and 61 degrees.

In order to achieve one or a portion of or all of the objects or other objects, an embodiment of the invention provides a display device including the backlight module and a display panel. The display panel is disposed on a side of the second prism sheet facing away from the first prism sheet.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a backlight module in an embodiment of the invention;

FIG. 2 is a schematic partial enlarged side view of the second prism sheet in FIG. 1;

FIG. 3 is a schematic partial enlarged side view of the inverse prism sheet in FIG. 1;

FIG. 4 is a schematic partial enlarged side view of the first prism sheet in FIG. 1;

FIG. 5 is a schematic diagram of the field of the light emitted in a configuration of the backlight module in FIG. 1;

FIG. 6 is a schematic partial enlarged side view of the second prism sheet of the backlight module in another embodiment of the invention;

FIG. 7 is a schematic side view of a backlight module in another embodiment of the invention;

FIG. 8 is a schematic diagram of the field of the light emitted from the backlight module in FIG. 7 in a sharing state and an anti-peeping state;

FIG. 9 is a schematic cross-sectional view of the anti-peeping panel in FIG. 8;

FIG. 10 is a schematic side view of a backlight module in another embodiment of the invention;

FIG. 11 is a schematic diagram of the field of the light emitted from the backlight module in FIG. 10;

FIG. 12 is a schematic side view of a backlight module in another embodiment of the invention;

FIG. 13 is a schematic side view of a backlight module in another embodiment of the invention;

FIG. 14 is a schematic side view of a backlight module in another embodiment of the invention;

FIG. 15 is a schematic side view of a display device in an embodiment of the invention;

FIG. 16 is a schematic side view of a display device in another embodiment of the invention; and

FIG. 17 is a schematic side view of a display device in another embodiment of the invention.

### DETAILED DESCRIPTION OF PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

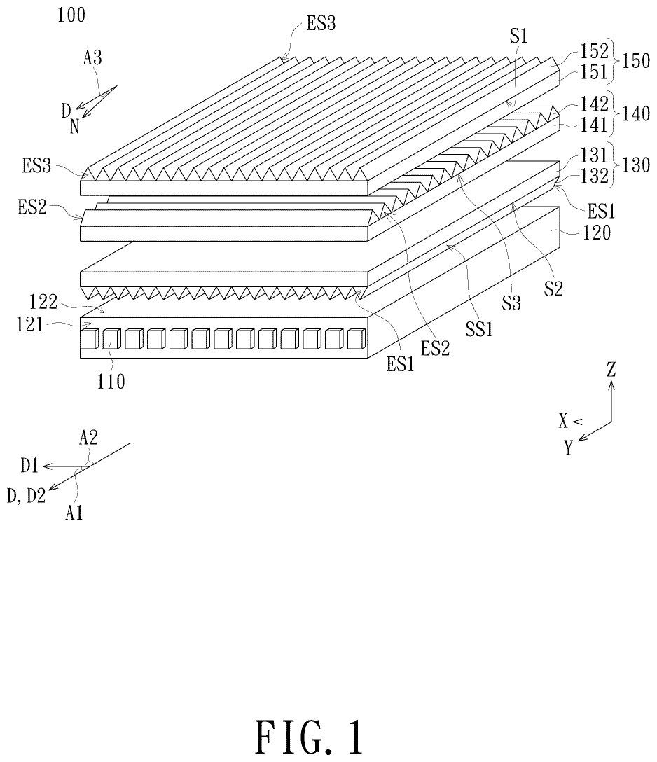

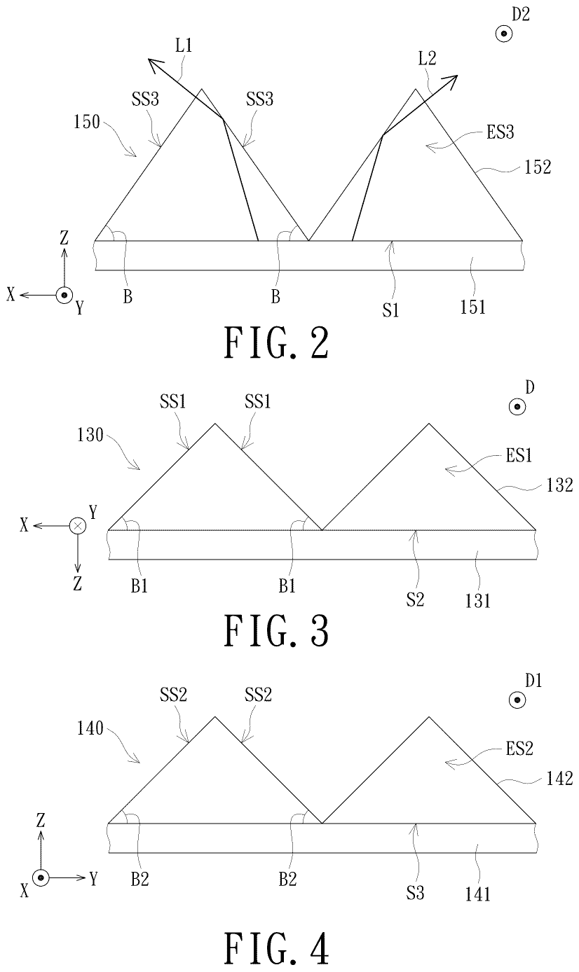

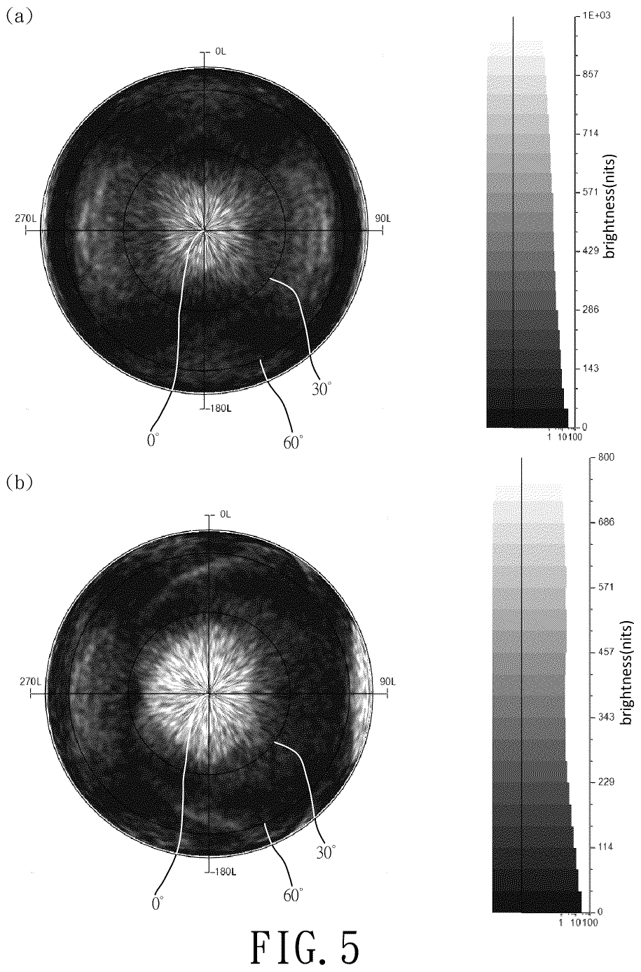

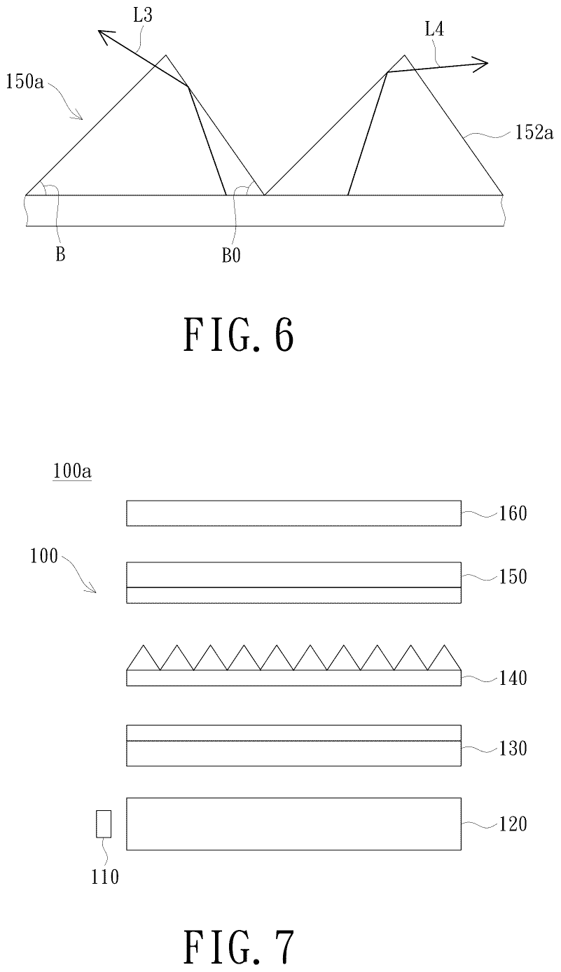

FIG. 1 is a schematic diagram of a backlight module in an embodiment of the invention. FIG. 2 is a schematic partial enlarged side view of the second prism sheet in FIG. 1. FIG. 3 is a schematic partial enlarged side view of the inverse prism sheet in FIG. 1. FIG. 4 is a schematic partial enlarged side view of the first prism sheet in FIG. 1. Specifically, FIG. 1, FIG. 2, FIG. 3, and FIG. 4 show the viewing angle relationship with directions X, Y, and Z. FIG. 5 is a schematic diagram of the field of the light emitted in a configuration of the backlight module in FIG. 1, wherein (a) is a schematic diagram of the field of the light emitted from the backlight module provided with the second prism sheet having two bottom angles equal in degrees, and (b) is a schematic diagram of the field of the light emitted from the backlight module provided with the second prism sheet having two bottom angles unequal in degrees. FIG. 6 is a schematic diagram of the second prism sheet of the backlight module in another embodiment of the invention.

Refer to FIGS. 1 and 2 first. A backlight module 100 includes a light-emitting element 110, a light guide plate 120, an inverse prism sheet 130, a first prism sheet 140, and a second prism sheet 150. The light guide plate 120 has a light incident surface 121 and a light-emitting surface 122 connected to the light incident surface 121, and the light incident surface 121 is opposite to the light-emitting element 110. The inverse prism sheet 130 is disposed on the light-emitting surface 122 of the light guide plate 120. The inverse prism sheet 130 has a plate body 131 and a plurality of prism columns 132. The prism columns 132 are disposed on a side of the plate body 131 facing the light-emitting surface 122, and the prism columns 132 extend toward a direction D, wherein the direction D is substantially the same as the direction Y. The first prism sheet 140 is disposed on a side of the inverse prism sheet 130 facing away from the light guide plate 120, and the first prism sheet 140 has a first plate body 141 and a plurality of first prism columns 142. The first prism columns 142 are disposed on a side of the first plate body 141 facing away from the inverse prism sheet 130, and the first prism columns 142 extend toward a first direction D1, wherein the first direction D1 is substantially the same as the direction X. An included angle A1 between the direction D and the first direction D1 is between 85 degrees and 95 degrees, and the included angle A1 in this embodiment is, for example, about 90 degrees. The second prism sheet 150 is disposed on a side of the first prism sheet 140 facing away from the inverse prism sheet 130, and the second prism sheet 150 has a second plate body 151 and a plurality of second prism columns 152. The second prism columns 152 are disposed on a side of the second plate body 151 facing away from the first prism sheet 140, and the second prism columns 152 extend toward a second direction D2, wherein the second direction D2 is substantially the same as the direction Y. An included angle A2 between the first direction D1 and the second direction D2 is between 85 degrees and 95 degrees, and the included angle A2 in this embodiment is, for example, about 90 degrees. Each of the second prism columns 152 has two bottom angles B, the two bottom angles B are connected to a surface S1 of the second plate body 151, and each of the two bottom angles B is between 51 and 61 degrees.

The light-emitting element 110 may include a LED (light-emitting diode). Furthermore, a number of the light-emitting diodes may be plural, and the emission wavelength may include blue light or white light, but the invention does not impose any restrictions on this.

Continue to refer to FIG. 1. The light guide plate 120 is configured to guide a light beam generated by the light-emitting element 110 to the inverse prism sheet 130. The material of the light guide plate 120 may include PMMA (polymethyl methacrylate) in this embodiment. However, the material of the light guide plate 120 may include COP (cyclo olefin polymer) or PC (polycarbonate) in other embodiments. Additionally, the light guide plate 120 in this embodiment may be manufactured by a method of hot pressing or injection molding.

Refer to FIGS. 1 and 3. The side of the inverse prism sheet 130 having the prism columns 132 is disposed as facing upward in FIG. 3 for the convenience of illustration. Please still refer to FIG. 1 for the specific direction of the prism columns 132. The plate body 131 of the inverse prism sheet 130 is, for example, disposed opposite to the light guide plate 120, and the prism columns 132 are fixed to a surface S2 of the plate body 131 facing the light-emitting surface 122. The prism column 132 may have two end surfaces ES1 opposite to each other, wherein the two end surfaces ES1 each stand on the surface S2, and the direction D points to one of the end surfaces ES1 from another one of the end surfaces ES1. For example, the direction D in this embodiment may be substantially parallel to the surface S2. An included angle A3 between a normal direction N of the light incident surface 121 and the direction D is, for example, between −5 degrees and +5 degrees in an embodiment to increase the brightness of the light emitted from the backlight module 100 at a large viewing angle in the horizontal viewing angle. It should be noted that the horizontal viewing angle herein refers to a central point of the light-emitting surface 122 of the light guide plate 120 viewed at different angles rotated on a virtual plane parallel to the light incident surface 121 of the light guide plate 120, and the vertical viewing angle refers to a center point of the light-emitting surface 122 of the light guide plate 120 viewed at different angles rotated on a virtual plane perpendicular to the light incident surface 121 of the light guide plate 120. For example, the included angle A3 may be approximately 0 degrees; that is, the normal direction N and the direction D may be substantially parallel to each other, or the direction D may be substantially perpendicular to the light incident surface 121 of the light guide plate 120. Additionally, the prism columns 132 of the inverse prism sheet 130 each have two first bottom angles B1 connected to the plate body 131, and the two first bottom angles B1 each may be between 42 degrees and 48 degrees. For example, the two first bottom angles B1 each may be approximately 45 degrees in an embodiment; that is, the two end surfaces ES1 of the prism column 132 may be roughly in manners of right triangles. It should be noted that each of the prism columns 132 has two side surfaces SS1 standing on the surface S2 of the plate body 131, and each of the two side surface SS1 is connected to the two end surfaces ES1. The first bottom angle B1 is an included angle between the side surface SS1 and the surface S2 of the plate body 131.

Refer to FIGS. 1 and 4. The first plate body 141 of the first prism sheet 140 is disposed opposite to the plate body 131 of the inverse prism sheet 130, and the first prism columns 142 are fixed to a surface S3 of the first plate body 141 facing away from the inverse prism sheet 130. Similarly, the first prism columns 142 may have two opposite end surfaces ES2 standing on the surface S3, the first direction D1 points to one of the end surfaces ES2 from another one of the end surfaces ES2, and the first direction D1 may be substantially parallel to the surface S3. The first prism columns 142 of the first prism sheet 140 each have two second bottom angles B2 connected to the first plate body 141, and the two second bottom angles B2 each may be between 42 degrees and 48 degrees. For example, the two second bottom angles B2 each may be approximately 45 degrees in an embodiment; that is, the two end surfaces ES2 of the first prism column 142 may be roughly in manners of isosceles right triangles, but the invention is not limited thereto. Likewise, the second bottom angle B2 is an included angle between the side surface SS2 of the first prism columns 142 and the surface S3 in this embodiment.

Refer to FIGS. 1 and 2. The second plate body 151 of the second prism sheet 150 is disposed opposite to the first plate body 141, and the second prism columns 152 are fixed to the surface S1 of the second plate body 151 facing away from the first prism sheet 140. Similarly, the second prism columns 152 may have two opposite end surfaces ES3 standing on the surface S1, the second direction D2 points to one of the end surfaces ES3 from another one of the end surfaces ES3, and the second direction D2 may be substantially parallel to the surface S1. The second direction D2 is, for example, substantially perpendicular to the first direction D1 of the first prism columns 142 and may be substantially parallel to the direction D of the prism columns 132 in an embodiment. The brightness of the light emitted from the backlight module 100 at the large angle in the horizontal viewing angle can be adjusted by adjusting the two bottom angles B of the second prism column 152. For example, the bottom angle B may be about 59 degrees in an embodiment, so the brightness of the light emitted at about +50 degrees and −50 degrees in the horizontal viewing angle can be increased. However, the invention does not impose any additional restrictions on the bottom angle B. It should be noted that each of the second prism columns 152 has two side surfaces SS3 standing on the surface S1, and each of the two side surfaces SS3 is connected to two end surfaces ES3 in this embodiment. The two bottom angles B each are an included angle between the side surface SS3 and the surface S1.

In addition, the two bottom angles B of each of the second prism columns 152 may have equal or unequal angles. For example, the two bottom angles B in this embodiment may have an equal angle, so the light beams L1 and L2 can be guided to be respectively emitted from the two side surfaces SS3 at a similar angle, thereby making the backlight module 100 be able to generate a roughly symmetrical light pattern in the horizontal viewing angle. For example, as shown in (a) of FIG. 5, when the two bottom angles B are, for example, both 59 degrees, the light emitted with the maximum brightness is located about at 0 degrees in the horizontal viewing angle, and light emitted with other larger brightness is located at about +50 degrees and −50 degrees in the horizontal viewing angle, wherein the other larger brightness is accounted for about 75% of the maximum brightness. In the embodiment shown in FIG. 6, the bottom angles B and B0 of each of the second prism sheets 150a may have unequal angles to guide the light beams L3 and L4 to be respectively emitted from the second prism columns 152a at angles significantly different from each other, thereby making the backlight module 100 be able to generate an asymmetric light pattern in the horizontal viewing angle. As shown in (b) of FIG. 5, for example, when the two bottom angles B are changed to 45 degrees and 59 degrees by changing the angle of one of the two bottom angles B, the light emitted with the maximum brightness is also located at about 0 degrees in the horizontal viewing angle, but the other light emitted with the other larger brightness is changed to about −58 degrees in the horizontal viewing angle shown in (b) of FIG. 5 from the angle at −50 degrees in the horizontal viewing angle shown in (a) of FIG. 5. Refer to FIG. 6 again. An angle difference between the bottom angles B and B0 of the second prism column 152a may be less than or equal to 3 degrees in an embodiment, but the invention is not limited thereto.

Compared with the prior art, the inverse prism sheet 130, the first prism sheet 140, and the second prism sheet 150 of the backlight module 100 in this embodiment are disposed on the light guide plate 120 in sequence, wherein the inverse prism sheet 130 is able to guide the light to be incident roughly perpendicularly onto the first prism sheet 140, and the first prism sheet 140 and the second prism sheet 150 each guide the light to be emitted at the large angle. Thus, the brightness of the light emitted at the large viewing angle in the vertical viewing angle and the horizontal viewing angle is increased. Additionally, the bottom angle B of the second prism column 152 is between 51 degrees and 61 degrees so the second prism column 152 is able to guide the light to be emitted at the larger angle, thereby further increasing the viewing angle in the horizontal viewing angle of the backlight module 100. As a result, the backlight module 100 in this embodiment is able to effectively increase the brightness of the light emitted at the large viewing angle without increasing the power consumption of the light-emitting element 110 and therefore solves the problems of energy waste and shortened product service life.

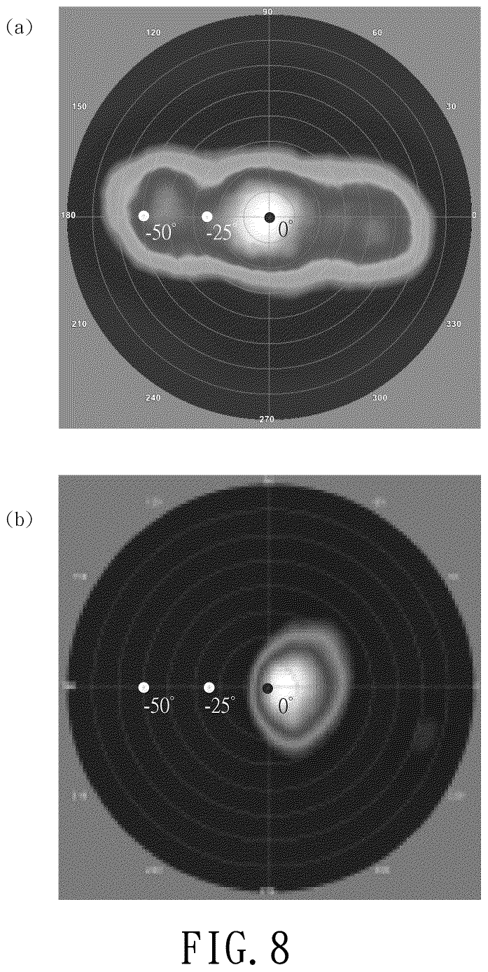

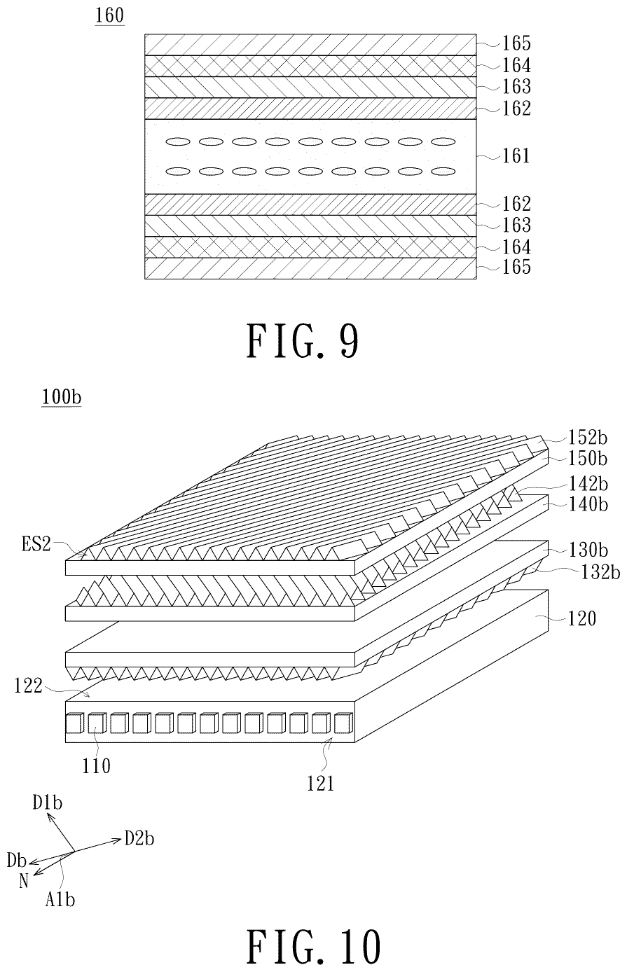

FIG. 7 is a schematic side view of a backlight module in another embodiment of the invention. FIG. 8 is a schematic diagram of the field of the light emitted from the backlight module in FIG. 7 in a sharing state and an anti-peeping state. FIG. 9 is a schematic cross-sectional view of the anti-peeping panel in FIG. 8. The structure and advantages of the backlight module 100a in this embodiment are similar to those in the embodiment of FIG. 1, and only the differences are described below. Refer to FIGS. 7 and 8 first. The backlight module 100a further includes, for example, an anti-peeping panel 160, and the anti-peeping panel 160 is disposed on a side of the second prism sheet 150 facing away from the first prism sheet 140. In other words, the backlight module 100a may be formed by the backlight module 100 in FIG. 1 and the anti-peeping panel 160. Specifically, the angle of the light emitted from the backlight module 100 can be controlled by the anti-peeping panel 160, so the backlight module 100a is able to be switched between the anti-peeping state and the sharing state. Because the brightness of the light emitted from the backlight module 100 at the large viewing angle can be increased by the inverse prism sheet 130, the first prism sheet 140, and the second prism sheet 150, the backlight module 100a is able to provide a sufficiently large viewing angle in the sharing state. For example, refer to (a) of FIG. 8. When the backlight module 100a is in the sharing state, the brightness of the light emitted between about 40 degrees to 60 degrees and −40 degrees to −60 degrees in the horizontal viewing angle is significantly increased; that is, the viewing angle of the backlight module 100a in the sharing state is significantly increased. Please refer to FIG. 7 and (b) of FIG. 8. When the backlight module 100a is in the anti-peeping state, the brightness of the light emitted at about greater than 25 degrees and less than −25 degrees in the horizontal viewing angle is significantly reduced, and the brightness of the light emitted at near about 0 degrees in the horizontal viewing angle is significantly increased. It is worth mentioning that a part of the light emitted from the light guide plate 120 is guided by the inverse prism sheet 130, the first prism sheet 140, and the second prism sheet 150 to be emitted at the large angle in the horizontal viewing angle; hence, the brightness of the light emitted from the backlight module 100a at a small angle (such as about 25 degrees and −25 degrees in the horizontal viewing angle) can be slightly reduced, thereby reducing the viewing angle of the backlight module 100a in the anti-peeping state to enhance the effectiveness of peeping protection.

Refer to FIG. 9. Incidentally, the anti-peeping panel 160 may include a liquid crystal layer 161, two alignment layers 162, two electrode layers 163, two substrates 164, and two polarizers 165 in an embodiment. Specifically, the liquid crystal layer 161 is sandwiched between the two alignment layers 162, wherein each of the alignment layers 162 may have a groove (not shown in the figure), and the grooves are able to allow long axes of liquid crystal molecules of the liquid crystal layer 161 to be arranged along the same direction in the case of no voltage being applied. The two alignment layers 162 are disposed between the two electrode layers 163. When the two electrode layers 163 are supplied with voltage to form an electric field between the two electrode layers 163, the liquid crystal molecules of the liquid crystal layers 161 are driven to rotate to change the emission angle of the light. The two electrode layers 163 may be disposed between the two substrates 164, and the two substrates 164 are disposed between the two polarizers 165. It is understandable that the features of the anti-peeping panel 160 are not limited to those shown in FIG. 9 in other embodiments.

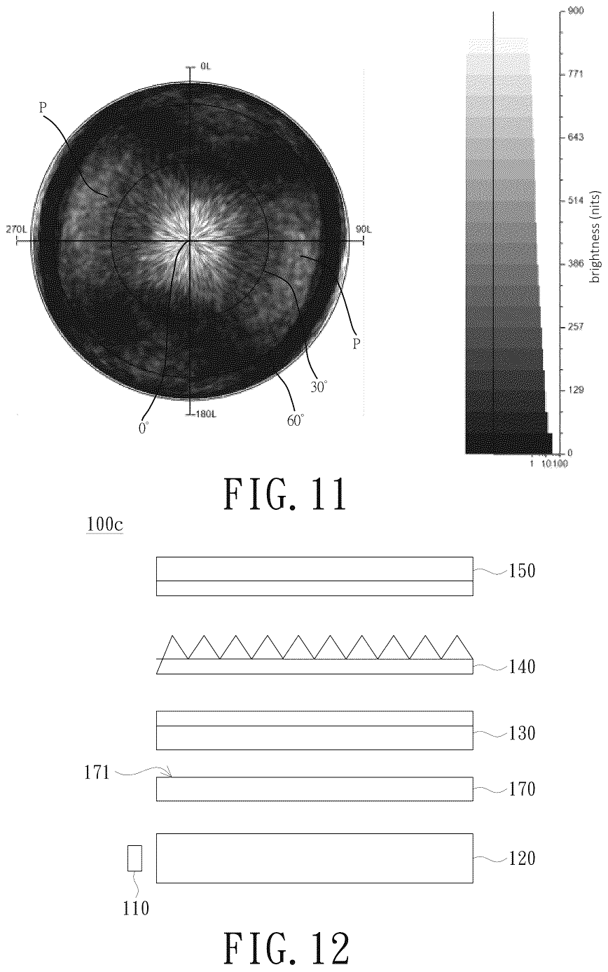

FIG. 10 is a schematic side view of a backlight module in another embodiment of the invention. FIG. 11 is a schematic diagram of the field of the light emitted from the backlight module in FIG. 10. The structure and advantages of the backlight module 100b in this embodiment are similar to those in the embodiment of FIG. 1, and only the differences are described below. Please refer to FIGS. 10 and 11. An included angle A1b between a normal direction N of the light incident surface 121 of the light guide plate 120 and a direction Db may be between −10 degrees and 30 degrees, and preferably between 10 degrees and 20 degrees. Furthermore, the prism columns 132b of the inverse prism sheet 130b, the first prism columns 142b of the first prism sheet 140b, and the second prism columns 152b of the second prism sheet 150b may rotate −10 degrees to 30 degrees, preferably 10 degrees to 20 degrees, in a manner parallel to the light-emitting surface 122, relative to the prism columns 132, the first prism columns 142, and the second prism columns 152 in FIG. 1. That is, the direction Db of the prism columns 132b, the first direction D1b of the first prism sheet 140b, and the second direction D2b of the second prism columns 152 b each are rotated by −10 degrees to 30 degrees (preferably 10 degrees to 20 degrees) in a manner parallel to the light-emitting surface 122, relative to the direction D, the first direction D1, and the second direction D2 in FIG. 1, so that the included angle A1b is changed to between −10 degrees and 30 degrees (preferably between 10 degrees and 20 degrees). Thus, the two peaks of brightness P of the light emitted from the backlight module 100b at large angles can be slightly deviated from the horizontal viewing angle so the two peaks of brightness P of the backlight module 100b at the large angles have a slight difference. For example, the backlight module 100b can be applied to a car display to facilitate the viewing of the display in front of the passenger side by the main driver. Also, the backlight module 100b can be provided with the anti-peeping panel 160 in FIG. 7 to provide two usage modes of the sharing state and the anti-peeping state in an embodiment.

FIG. 12 is a schematic side view of a backlight module in another embodiment of the invention. The structure and advantages of the backlight module 100c in this embodiment are similar to those in the embodiment of FIG. 1, and only the differences are described below. Please refer to FIG. 12. The backlight module 100c can further include a diffusion sheet 170, and the diffusion sheet 170 is disposed between the light guide plate 120 and the inverse prism sheet 130 to improve uniformity of the light emitted from the backlight module 100c. Specifically, a surface 171 of the diffusion sheet 170 may have a plurality of microstructures, or a plurality of reflective particles may be disposed in the diffusion sheet 170, and the invention does not impose any restrictions on the specific structure of the diffusion sheet 170.

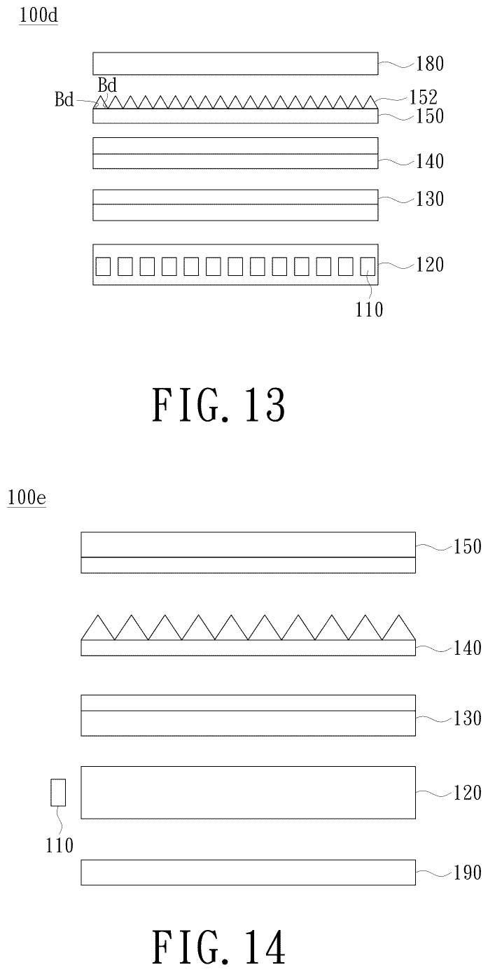

FIG. 13 is a schematic side view of a backlight module in another embodiment of the invention, wherein FIG. 13 has a different angle of view from FIG. 12. The structure and advantages of the backlight module 100d in this embodiment are similar to those in the embodiment of FIG. 1, and only the differences are described below. Please refer to FIG. 13. The backlight module 100d can further include a brightness enhancement sheet 180, and the brightness enhancement sheet 180 is disposed on a side of the second prism sheet 150 facing away from the first prism sheet 140 to improve the brightness of the light emitted from the backlight module 100d. The brightness enhancement sheet 180 includes, for example, a DBEF (dual brightness enhancement film), but the invention is not limited thereto. The backlight module 100d may be provided with the anti-peeping panel 160 of FIG. 7, and the anti-peeping panel 160 can be disposed on a side of the brightness enhancement sheet 180 facing away from the second prism sheet 150 in an embodiment. Incidentally, because the backlight module 100d is provided with the brightness enhancement sheet 180, the two bottom angles Bd of the second prism sheet 150 may be about 57 degrees in an embodiment to increase the brightness of the light emitted from the backlight module 100 d at about 50 degrees and −50 degrees in the horizontal viewing angle, but the invention does not impose any restrictions on the bottom angles Bd.

FIG. 14 is a schematic side view of a backlight module in another embodiment of the invention. The structure and advantages of the backlight module 100e in this embodiment are similar to those in the embodiment of FIG. 1, and only the differences are described below. Please refer to FIG. 14. The backlight module 100e further includes, for example, a reflective sheet 190, and the reflective sheet 190 is disposed on a side of the light guide plate 120 facing away from the inverse prism sheet 130 to improve the light utilization efficiency of the backlight module 100e. The material of the reflective sheet 190 may include silver in this embodiment, but the invention does not impose any restrictions on this.

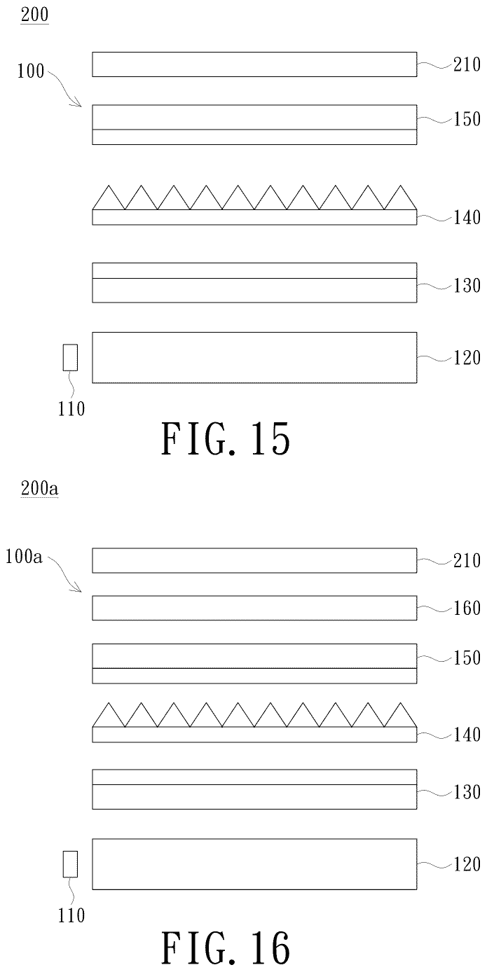

FIG. 15 is a schematic side view of a display device in an embodiment of the invention. Please refer to FIG. 15. A display device 200 includes the backlight module 100 and a display panel 210. The display panel 210 is disposed on a side of the second prism sheet 150 facing away from the first prism sheet 140. The display panel 210 may include a liquid crystal display panel in this embodiment, and the backlight module 100 is able to provide light to the display panel 210. However, the invention does not impose any restrictions on the type of the display panel 210.

Compared with the prior art, by adopting the backlight module 100, the display device 200 in this embodiment is able to effectively increase the viewing angle and therefore solves the problems of energy waste and shortened product service life. The display device 200 can adopt the backlight module 100a, 100b, 100c, 100d, or 100e in other embodiments.

FIG. 16 is a schematic side view of a display device in another embodiment of the invention. The structure and advantages of the display device 200a in this embodiment are similar to those in the embodiment of FIG. 15, and only the differences are described below. Please refer to FIG. 16. The backlight module 100a can further include the anti-peeping panel 160, and the anti-peeping panel 160 is disposed between the second prism sheet 150 and the display panel 210. In other words, the display device 200a adopts the backlight module 100a in FIG. 7 and the display panel 210 so the display device 200a has two usage modes of the sharing state and the anti-peeping state. The features of the anti-peeping panel 160 are described in detail above, and no redundant detail is to be given herein.

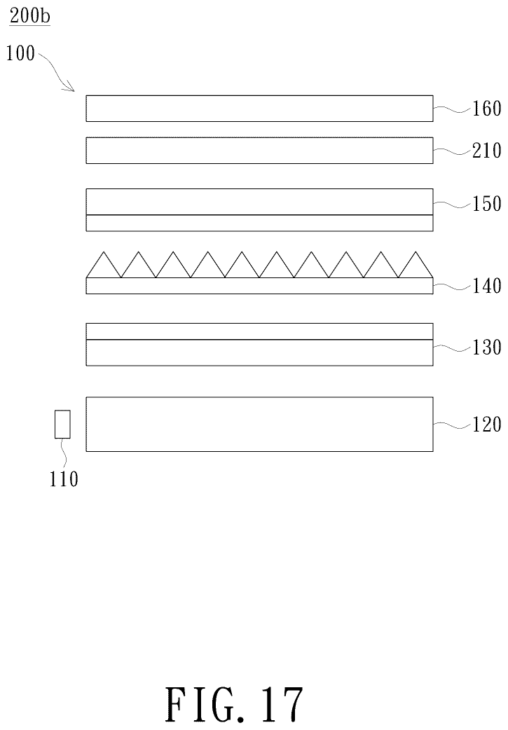

FIG. 17 is a schematic side view of a display device in another embodiment of the invention. The structure and advantages of the display device 200b in this embodiment are similar to those in the embodiment of FIG. 15, and only the differences are described below. Please refer to FIG. 17. The display device 200b may further include the anti-peeping panel 160, and the anti-peeping panel 160 is disposed on a side of the display panel 210 facing away from the second prism sheet 150, so the display device 200b has two usage modes of the sharing state and the anti-peeping state.

In summary, the backlight module and the display device in the embodiments of the invention have at least one of the following advantages. The inverse prism sheet, the first prism sheet, and the second prism sheet of the backlight module of the invention are disposed on the light guide plate in sequence, wherein the inverse prism sheet is able to guide the light to be incident roughly perpendicularly onto the first prism sheet, and the first prism sheet and the second prism sheet each guide the light to be emitted at a large angle. Thus, the brightness of the light emitted at a large viewing angle in the vertical viewing angle and the horizontal viewing angle is increased. Additionally, the bottom angle of the second prism column is between 51 degrees and 61 degrees so the second prism column is able to guide the light to be emitted at a larger angle, thereby further increasing the viewing angle in the horizontal viewing angle of the backlight module. For these reasons, the backlight module of the invention is able to effectively increase the brightness of the light emitted at the large viewing angle without increasing power consumption of the light-emitting element, and therefore solves the problems of energy waste and shortened product service life. By adopting the backlight module, the display device of the invention is able to effectively increase the viewing angle and therefore solves the problems of energy waste and shortened product service life.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of . . . and . . . ” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising:
a light-emitting element;
a light guide plate, having a light incident surface and a light-emitting surface connected to the light incident surface, wherein the light incident surface is opposite to the light-emitting element;
an inverse prism sheet, disposed on the light-emitting surface of the light guide plate, wherein the inverse prism sheet has a plate body and a plurality of prism columns, the plurality of prism columns are disposed on a side of the plate body facing the light-emitting surface, and the plurality of prism columns extend toward a direction;
a first prism sheet, disposed on a side of the inverse prism sheet facing away from the light guide plate, wherein the first prism sheet has a first plate body and a plurality of first prism columns, the plurality of first prism columns are disposed on a side of the first plate body facing away from the inverse prism sheet, the plurality of first prism columns extend toward a first direction, and an included angle between the direction and the first direction is between 85 degrees and 95 degrees; and
a second prism sheet, disposed on a side of the first prism sheet facing away from the inverse prism sheet, wherein the second prism sheet has a second plate body and a plurality of second prism columns, the plurality of second prism columns are disposed on a side of the second plate body facing away from the first prism sheet, the plurality of second prism columns extend toward a second direction, an included angle between the first direction and the second direction is between 85 degrees and 95 degrees, each of the plurality of second prism columns has two bottom angles, the two bottom angles are connected to a surface of the second plate body, and each of the two bottom angles is between 51 degrees and 61 degrees.

2. The backlight module according to claim 1, wherein an included angle between a normal direction of the light incident surface and the direction is between −5 degrees and +5 degrees.

3. The backlight module according to claim 1, wherein an included angle between a normal direction of the light incident surface and the direction is between −10 degrees and 30 degrees.

4. The backlight module according to claim 1, wherein the two bottom angles of each of the plurality of second prism columns have equal or unequal angles.

5. The backlight module according to claim 4, wherein an angle difference between the two bottom angles is less than or equal to 3 degrees.

6. The backlight module according to claim 1, wherein the plurality of prism columns of the inverse prism sheet each have two first bottom angles connected to the plate body, the plurality of first prism columns of the first prism sheet each have two second bottom angles connected to the first plate body, and the two first bottom angles and the two second bottom angles each are between 42 degrees and 48 degrees.

7. The backlight module according to claim 1, further comprising an anti-peeping panel, wherein the anti-peeping panel is disposed on a side of the second prism sheet facing away from the first prism sheet.

8. The backlight module according to claim 1, further comprising a diffusion sheet, wherein the diffusion sheet is disposed between the light guide plate and the inverse prism sheet.

9. The backlight module according to claim 1, further comprising a brightness enhancement sheet, wherein the brightness enhancement sheet is disposed on a side of the second prism sheet facing away from the first prism sheet.

10. The backlight module according to claim 1, further comprising a reflective sheet, wherein the reflective sheet is disposed on a side of the light guide plate facing away from the inverse prism sheet.

11. A display device, comprising:
a backlight module, comprising:
a light-emitting element;
a light guide plate, having a light incident surface and a light-emitting surface connected to the light incident surface, wherein the light incident surface is opposite to the light-emitting element;
an inverse prism sheet, disposed on the light-emitting surface of the light guide plate, wherein the inverse prism sheet has a plate body and a plurality of prism columns, the plurality of prism columns are disposed on a side of the plate body facing the light-emitting surface, and the plurality of prism columns extend toward a direction;
a first prism sheet, disposed on a side of the inverse prism sheet facing away from the light guide plate, wherein the first prism sheet has a first plate body and a plurality of first prism columns, the plurality of first prism columns are disposed on a side of the first plate body facing away from the inverse prism sheet, the plurality of first prism columns extend toward a first direction, and an included angle between the direction and the first direction is between 85 degrees and 95 degrees; and
a second prism sheet, disposed on a side of the first prism sheet facing away from the inverse prism sheet, wherein the second prism sheet has a second plate body and a plurality of second prism columns, the plurality of second prism columns are disposed on a side of the second plate body facing away from the first prism sheet, the plurality of second prism columns extend toward a second direction, an included angle between the first direction and the second direction is between 85 degrees and 95 degrees, each of the second prism columns has two bottom angles, the two bottom angles are connected to a surface of the second plate body, and each of the two bottom angles is between 51 degrees and 61 degrees; and
a display panel, disposed on a side of the second prism sheet facing away from the first prism sheet.

12. The display device according to claim 11, wherein the backlight module further comprises an anti-peeping panel, and the anti-peeping panel is disposed between the second prism sheet and the display panel.

13. The display device according to claim 11, further comprising an anti-peeping panel, wherein the anti-peeping panel is disposed on a side of the display panel facing away from the second prism sheet.
